(19) United States
(12) Patent Application Publication
(10) Pub. No.: US 2023/0060487 A1
(43) Pub. Date: Mar. 2, 2023

(54) MOTOR DEVICE

(71) Applicant: OMRON Corporation, Kyoto-shi (JP)

(72) Inventor: Takeshi KIRIBUCHI, Kyoto-shi (JP)

(21) Appl. No.: 17/875,836

(22) Filed: Jul. 28, 2022

(30) Foreign Application Priority Data
Aug. 25, 2021 (JP) 2021-137230

(51) Int. Cl. H04L 67/12

(52) U.S. Cl. CPC H04L 67/12

(57) ABSTRACT

A network that allows exchange of information for operating a system including a motor can be created with reduced workload. A motor drivable with driving power supplied from a first driver in a servo system includes a first communicator that at least transmits or receives a predetermined signal through wireless communication between a first device and the motor included in the servo system, and a second communicator that performs predetermined communication of the predetermined signal between a second device and the motor.

### CROSS-REFERENCE TO RELATED APPLICATION

This application claims priority to Japanese Patent Application No. 2021-137230 filed on Aug. 25, 2021, the contents of which are incorporated herein by reference.

### FIELD

The present invention relates to a motor.

### BACKGROUND

In factory automation (FA) at facilities such as factories, a main controller transmits control commands to field devices (e.g., motors), and the field devices transmit various items of information to the main controller to perform integrated control in a manufacturing system. For efficient operation, FA facilities use networks for transmitting and receiving information. For example, Patent Literature 1 describes a communication system including wireless repeaters for relaying communication between field devices and a controller. Patent Literature 2 describes a network for an FA line including field devices that can communicate with a main controller through a main repeater connected to the controller with Ethernet and through repeaters connected wirelessly to the main repeater.

Motors are common actuators for various industrial devices at factories. For example, Patent Literature 3 describes fan filter units as industrial devices. The fan filter units are divided into groups of multiple fan filter units. The fan filter units included in each group are controlled by a host device with a repeater corresponding to the group relaying communication between the host device and motors in the fan filter units.

### CITATION LIST

### Patent Literature

Patent Literature 1: Japanese Unexamined Patent Application Publication No. 2005-333189

Patent Literature 2: Japanese Unexamined Patent Application Publication No. 2004-64722

Patent Literature 3: Japanese Unexamined Patent Application Publication No. 2011-147279

### SUMMARY

### Technical Problem

At manufacturing sites or other sites at factories, motors are common power sources for, for example, transporting or machining components. Motors receive electric power and produce mechanical output. Motors are not limited to specific types and may be alternating-current (AC) motors, direct-current (DC) motors, rotary actuators, or linear actuators. Multiple motors can be combined to produce mechanical output for an intended production line or other equipment. A production line or other equipment with more motors includes more control shafts and is likely to increase information to be exchanged for accurate control.

A recent production line or other equipment, in particular, includes multiple sensors to appropriately determine the status of the equipment and to, for example, increase production efficiency or reduce energy consumption. This complicates the network for transmitting detection signals from the sensors to destinations and increases the workload for creating the network.

In response to the above issue, one or more aspects of the present invention are directed to a technique for reducing the workload for creating a network that allows exchange of information for operating a system including a motor.

### Solution to Problem

A motor according to one aspect of the present disclosure is a motor drivable with driving power supplied from a first driver in a servo system. The motor includes a first communicator that at least transmits or receives a predetermined signal through wireless communication between a first device and the motor included in the servo system, and a second communicator that performs predetermined communication of the predetermined signal between a second device and the motor.

The above motor is included in the servo system and servo-controlled with driving power supplied from the first driver included in the servo system. The motor may have any of various known structures that are servo-controlled by the first driver. For example, the motor may operate on AC power or DC power as the driving power supplied from the first driver. The motor may be a rotary actuator or a linear actuator. The servo system may include components other than the first driver and the motor. For example, the servo system may include other motors, drivers corresponding to the motors, and a controller for providing control signals for the motors to the drivers.

The above motor includes the first communicator for performing wireless communication with the first device included in the servo system. The wireless communication refers to at least transmitting or receiving the predetermined signal wirelessly. The wireless communication performed by the first communicator is thus at least communication from the first device to the motor or communication from the motor to the first device. The motor includes the second communicator that performs the predetermined communication of the predetermined signal included in the wireless communication. The predetermined communication may be wireless communication or wired communication. The second device may be included in the servo system or external to the servo system.

The motor with this structure included in the servo system can relay information between the first device in the servo system and the second device. In an example, the first communicator may receive the predetermined signal from the first device, and the second device may transmit the received predetermined signal to the second device with or without signal processing. In another example, the second communicator may receive information from the second device, and the first communicator may transmit the received information to the first device as the predetermined signal with or without signal processing. The motor can relay information in a manner in at least one of these examples. The first communicator performs wireless communication between the first device and the motor. This eliminates cabling for creating the network in the servo system, greatly reducing the workload.

The motor is typically a power source for, for example, equipment drivable by the servo system. The system includes as many motors as the control shafts in the equipment. The system can thus easily include a sufficient number of motors to serve as repeaters for information between the first device and the second device as described above. The equipment may include many sensors for detecting parameters about, for example, the motion or the states of control shafts. Motors in such equipment may also serve as repeaters for collecting detection signals from the sensors. This structure greatly facilitates creation of the servo system including the network for exchanging information.

In the above motor, the second communicator may perform the predetermined communication between the second device and the motor at least partially using a power line connecting the motor and the first driver. The power line can be used for the predetermined communication to eliminate an additional communication line for the predetermined communication between the motor and the second device. This reduces the workload for creating the network. In this example, the motor may allow transmission or reception of a signal between an encoder to detect motion of an output shaft of the motor drivable by the first driver and a winding of the motor. The first communicator and the second communicator may be included in the encoder. The motor with this structure exchanges information with the first device and the second device with signals transmitted or received between the encoder and the winding in the motor that is electrically connected to the power line.

The above motor may further include an encoder that detects motion of an output shaft of the motor drivable by the first driver. In this case, the first communicator and the second communicator may be included in the encoder. The second communicator may perform the predetermined communication using a communication cable connecting the first driver and the encoder. The communication cable can be used for the predetermined communication to eliminate an additional communication line for the predetermined communication between the motor and the second device. This reduces the workload for creating the network.

The above motor may further include a power line connecting the motor and the first driver, and a signal processor that superimposes the predetermined signal on a driving current flowing through the power line or extracts the predetermined signal from the driving current flowing through the power line. The first communicator and the second communicator may be included in the signal processor. In other words, the motor includes the power line and the signal processor. The motor with this structure can also use the power line for the predetermined communication and eliminate an additional communication line for the predetermined communication between the motor and the second device. This reduces the workload for creating the network.

In the above motor, the second communicator may perform the predetermined communication through wireless communication between the second device and the motor. This structure also reduces the workload for creating the network.

In the motor in any of the above examples, the first device may include a first sensor that detects a predetermined parameter in the servo system. In this case, the first communicator may receive a detection signal from the first sensor. The second communicator may transmit the detection signal received by the first communicator to the first driver being the second device. This structure facilitates collection of the detection signal from the first sensor through the motor.

For the first device including the first sensor as described above, the first sensor may detect the predetermined parameter about a displacement of a first driving target drivable by an output shaft of the motor. In this case, the first communicator may be located to receive the detection signal from the first sensor. Before a sensor identification process is complete, a first predetermined operation may be performed to displace the first driving target by driving the output shaft of the motor. In response to the first communicator receiving the detection signal from the first sensor in the first predetermined operation, the second communicator may transmit the detection signal received by the first communicator from the first sensor to the first driver to link the first driver and the first sensor. This structure can easily link the first driver and the first sensor before the servo system is activated.

In the above structure, the servo system may include a second driver connected to the first driver to allow communication, a second motor drivable with driving power supplied from the second driver, and a second sensor that detects a parameter about a displacement of a second driving target drivable by an output shaft of the second motor. In this case, the first communicator may be located to receive a detection signal from the second sensor. Before the sensor identification process is complete, a second predetermined operation may be performed to displace the second driving target by driving the output shaft of the second motor. In response to the first communicator receiving the detection signal from the second sensor in the second predetermined operation, the second communicator may transmit the detection signal received by the first communicator from the second sensor to the second driver through the first driver to link the second driver and the second sensor. This structure can easily link the second driver and the second sensor before the servo system is activated.

For the first device including the first sensor as described above, the first sensor may detect the predetermined parameter about a displacement of a first driving target drivable by an output shaft of the motor. In this case, the servo system may include a second driver connected to the first driver to allow communication and a second motor drivable with driving power supplied from the second driver. The second motor may receive the predetermined signal from the first sensor through wireless communication, and perform the predetermined communication with the first driver. The motor or the second motor may be selected to receive the detection signal from the first sensor based on a result of comparison between an intensity of a signal between the first communicator and the first sensor and an intensity of a signal between the first sensor and the second motor. This structure allows more stable wireless communication between the first sensor and the motor.

In response to the motor receiving the detection signal from the first sensor, the first communicator may receive the detection signal from the first sensor, and the second communicator may transmit the detection signal received by the first communicator to the first driver. In response to the second motor receiving the detection signal from the first sensor, the second motor may relay the detection signal to the first driver optionally through the motor. More specifically, the first communicator may receive the detection signal from the second motor, and the second communicator may transmit the detection signal received by the first communicator to the first driver. This structure allows the detection signal from the first sensor to be transmitted to the first driver through the motor with a higher-intensity signal, thus allowing more stable collection of information.

For the first device including the first sensor as described above, the first communicator may transmit, to the first sensor with a contactless power transmission scheme, the predetermined signal indicating power for driving the first sensor. The motor with this structure supplies power to drive the first sensor with the contactless power transmission scheme, thus allowing smooth activation of the servo system including the first sensor.

In the above motor, the first communicator may transmit, with the contactless power transmission scheme, the predetermined signal based on information transmitted from the first sensor indicating an amount of power for driving the first sensor. This structure allows more efficient power supply to the first sensor.

In the motor in any of the above examples, the servo system may include a second driver connected to the first driver to allow communication and a second motor drivable with driving power supplied from the second driver. In this case, the second motor may receive the predetermined signal from the first sensor through wireless communication, and perform the predetermined communication with the first driver. The motor or the second motor may be selected to transmit the predetermined signal based on a result of comparison between an intensity of a signal between the first communicator and the first sensor and an intensity of a signal between the first sensor and the second motor. This structure allows more stable power transmission to the first sensor with the contactless power transmission scheme.

The above motor in an exemplary form may include an integral motor including a motor body and the first driver integral with each other, and the integral motor may drive a first driving target. In this case, the second communicator may perform the predetermined communication with the second device through a predetermined section in the integral motor corresponding to the first driver or with the predetermined section being bypassed. In other words, the integral motor may exchange information with the first device and the second device using the above first communicator and the second communicator through the predetermined section in the integral motor corresponding to the first driver or without using the predetermined section.

In the above motor, the first device may include a controller that generates a command signal for controlling a plurality of control targets including the first driving target in the servo system. In this case, the second device may include a second driver connected to the predetermined section to allow communication to supply a driving current to a second motor to drive a second driving target. The first communicator may receive a command signal for controlling the second motor from the controller. The second communicator may transmit the command signal received by the first communicator to the second driver. With this structure, the controller can control the second motor using the motor.

In another example, the motor may include an integral motor including a motor body and the first driver integral with each other, and the integral motor may drive a first driving target. In this case, the first device may include a controller that generates a command signal for controlling the first driving target in the servo system. The second device may include a predetermined section in the integral motor corresponding to the first driver. The first communicator may receive the command signal from the controller. The second communicator may transmit the command signal received by the first communicator to the predetermined section. In other words, the integral motor is controlled with the control signal transmitted from the controller to the predetermined section in the integral motor corresponding to the first driver using the above first communicator and the second communicator.

### Advantageous Effects

The technique reduces the workload for creating a network that allows exchange of information for operating a system including a motor.

### BRIEF DESCRIPTION OF THE DRAWINGS

FIG. 1 is a first schematic diagram of a servo system.

FIG. 2 is a schematic diagram of equipment operable by the servo system.

FIG. 3 is a first schematic diagram of a motor.

FIG. 4 is a second schematic diagram of a motor.

FIG. 5 is a diagram of a winding structure in the motor shown in FIG. 4.

FIG. 6 is a third schematic diagram of a motor.

FIG. 7 is a flowchart showing the control for establishing communication between sensors and motors performed in the servo system including the motors.

FIG. 8 is a flowchart showing the control for linking the sensors and servo drivers performed in the servo system including the motors.

FIG. 9A is a first sequence diagram showing a sequence of communication between a programmable logic controller (PLC) and the servo drivers when the control shown in FIG. 8 is performed.

FIG. 9B is a second sequence diagram showing a sequence of communication between the PLC and the servo drivers when the control shown in FIG. 8 is performed.

FIG. 10 is a second schematic diagram of a servo system.

FIG. 11 is a fourth schematic diagram of a motor.

### DETAILED DESCRIPTION

Embodiments of the present disclosure will now be described in detail with reference to the drawings. The same or corresponding components in the figures are given the same reference numerals, and will not be described repeatedly. The motor according to an exemplary embodiment of the present disclosure is included in a servo system in equipment usable for manufacturing at, for example, a factory.

### First Embodiment

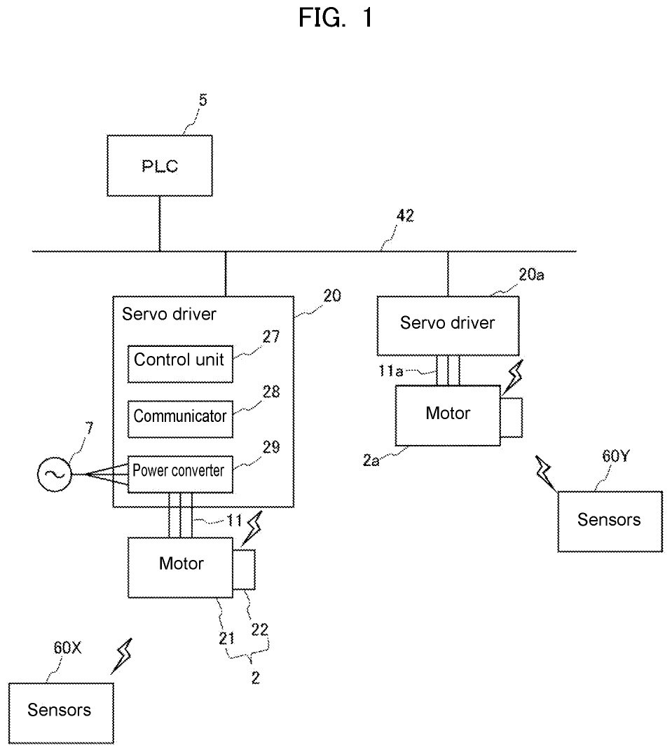

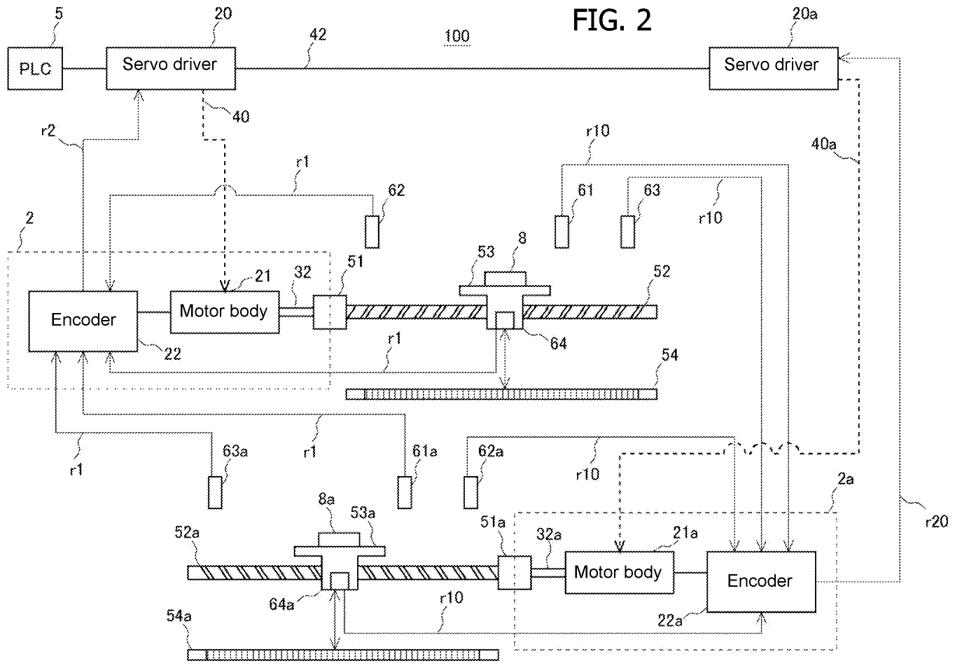

FIG. 1 is a schematic diagram of a servo system included in equipment shown in FIG. 2 described later. The servo system drives and controls the motor and includes a programmable logic controller (PLC) 5, servo drivers 20 and 20a, motors 2 and 2a, and sensors 60X and 60Y. More specifically, the servo system includes the PLC 5 as a host controller connected to a network 42. The network 42 is connected to multiple servo drivers 20 that can transmit or receive signals to or from the PLC 5. Although FIG. 1 shows the functional components of the servo driver 20 in detail as a typical example, the servo driver 20a also includes functional components equivalent to those of the servo driver 20. The motor 2 is connected to the servo driver 20 with a power line 11 and receives driving power from the servo driver 20. Similarly, the motor 2a receives driving power from the servo driver 20a through the power line 11a. The structures of the motor 2 and the servo driver 20 are described below as typical examples.

The motor 2 is driven and controlled in accordance with commands from the PLC 5 to drive predetermined equipment. Examples of the equipment include various machines (e.g., industrial robotic arms and conveyors). The motor 2 is included in the equipment as an actuator for driving the equipment. The motor 2 is an AC servo motor. In some embodiments, the motor 2 may be an induction motor or a DC motor. The motor 2 includes a motor body 21 and an encoder 22. The motor body 21 includes a stator and a rotor. The stator includes a winding unit including stator cores and coils wound around the stator cores. The rotor incorporates permanent magnets. The encoder 22 includes a detection disc rotatable as the rotor rotates to detect the rotation of the rotor. The encoder 22 may detect the rotation in an incremental manner or an absolute manner. The detection signal from the encoder 22 is transmitted wirelessly to the servo driver 20 through a communicator 28 (described later) included in the servo driver 20. The transmitted detection signal is used for servo control in a control unit 27 (described later) included in the servo driver 20. The detection signal from the encoder 22 includes, for example, positional information about the rotational position (angle) of the rotation shaft of the motor 2 and information about the rotational speed of the rotation shaft.

The servo driver 20 includes the control unit 27, the communicator 28, and a power converter 29. The control unit 27 is a functional unit for performing servo control of the motor 2 based on commands from the PLC 5. The control unit 27 receives motion command signals about the motion of the motor 2 from the PLC 5 through the network 42 and receives detection signals from the encoder 22. The control unit 27 then performs servo control for driving the motor 2, or specifically, calculates command values about the motion of the motor 2. The control unit 27 performs, for example, feedback control using a position controller, a speed controller, and a current controller. The control unit 27 also performs control in the servo driver 20 other than the servo control of the motor 2.

The communicator 28 is a functional unit for performing wireless communication between the motor 2 and the servo driver 20. To start wireless communication, the communicator 28 in the servo driver 20 identifies its communication target motor, thus identifying the encoder 22 as a target of wireless communication. Once identifying the encoder, the communicator 28 performs wireless communication with the encoder without crosstalk with the motor 2a. Similarly, the motor 2a performs wireless communication with the servo driver 20a alone. The power converter 29 supplies driving power to the motor 2 through the power line 11 based on the command value about the motion of the motor 2 calculated by the control unit 27. The supply power is AC power from an AC power supply 7 to the servo driver 20. In the present embodiment, the servo driver 20 receives a three-phase alternating current. In another embodiment, the servo driver 20 may receive a single-phase alternating current.

The sensors 60X and 60Y shown in FIG. 1 detect predetermined parameters about driving the motors 2 and 2a. Detection signals from the sensors 60X are transmitted to the motor 2 through wireless communication. Detection signals from the sensors 60Y are transmitted to the motor 2a through wireless communication. More specifically, the sensors 60X collectively refer to an origin sensor 61a, limit sensors 62 and 63a, and a fully closed sensor 64 shown in FIG. 2 (described later). The sensors 60Y collectively refer to an origin sensor 61, limit sensors 62a and 63, and a fully closed sensor 64a.

The schematic structure of the equipment including the servo system in FIG. 1 will now be described with reference to FIG. 2. The equipment includes two control shafts that are drivable by the motors 2 and 2a. The motors 2 and 2a include output shafts 32 and 32a connected to screw shafts 52 and 52a with couplings 51 and 51a. The screw shafts 52 and 52a include precision tables 53 and 53a that are displaced when the motors 2 and 2a are driven. The precision tables 53 and 53a receive workpieces 8 and 8a. The equipment in FIG. 2 includes the two control shafts, or specifically the control shaft drivable by the motor 2 and the control shaft drivable by the motor 2a. The equipment may include three or more control shafts.

The control shaft drivable by the motor 2 includes a linear scale 54, the origin sensor 61, the limit sensors 62 and 63, and the fully closed sensor 64. The control shaft drivable by the motor 2a includes a linear scale 54a, the origin sensor 61a, the limit sensors 62a and 63a, and the fully closed sensor 64a. The sensors detect parameters about the displacements of the precision tables 53 and 53a as the detection targets. The sensors transmit detection signals to the motor 2 or 2a through wireless communication (described in detail later).

The origin sensors 61 and 61a detect the origin positions of the precision tables 53 and 53a. The origin sensors 61 and 61a output on-signals in response to the stages reaching their limit positions, and output off-signals in response to the stages being at other positions. The limit sensors 62, 63, 62a, and 63a detect the edge positions of the movable range of the precision tables 53 and 53a on the control shafts. The limit sensors 62, 63, 62a, and 63a output on-signals in response to the stages reaching their edge positions, and output off-signals in response to the stages being at other positions. In response to the limit sensor 62 or other limit sensors being turned on, for example, the motor 2 stops to stop the precision table 53. Each of the origin sensors and the limit sensors may be, for example, a photoelectric sensor, a proximity sensor, or a fiber sensor. In some embodiments, each of the origin sensors and the limit sensors may be an image sensor. In this case, the detection signal from each sensor is an image signal.

The linear scales 54 and 54a are located along the screw shafts 52 and 52a. The linear scales 54 and 54a are, for example, reflective photoelectric glass scales with slits arranged with a regular pitch. The fully closed sensors 64 and 64a are located on the precision tables 53 and 53a and movable together with the precision tables 53 and 53a. The fully closed sensors 64 and 64a include light emitters and light receivers (not shown). The light emitters emit light that is reflected on the corresponding slits in the linear scales 54 and 54a and produces interference fringes on the light receivers. The interference fringes move as the precision tables 53 and 53a move. The output signals from the light receivers thus have intensities changing with the movement of the precision tables 53 and 53a. The changes in intensities of the output signals from the light receivers can be monitored to determine the displacements of the precision tables 53 and 53a. In other words, the fully closed sensors 64 and 64a output detection signals for calculating the displacements of the precision tables 53 and 53a, and the detection signals are used for fully closed control in the servo drivers 20 and 20a.

The PLC 5 outputs command signals to the servo drivers 20 and 20a. The PLC 5 performs a process in accordance with a predetermined program and serves as, for example, a device for monitoring the servo drivers 20 and 20a. The servo drivers 20 and 20a receive command signals from the PLC 5. The servo drivers 20 and 20a receive feedback signals from the motors 2 and 2a, and also receive the detection signals from the corresponding sensor of the origin sensors 61 and 61a, the limit sensor 62, 63, 62a, and 63a, and the fully closed sensors 64 and 64a through the motors 2 and 2a. The transmission and reception of signals between the servo driver 20 and the sensors through the motor 2 in three examples will now be described.

### FIRST EXAMPLE

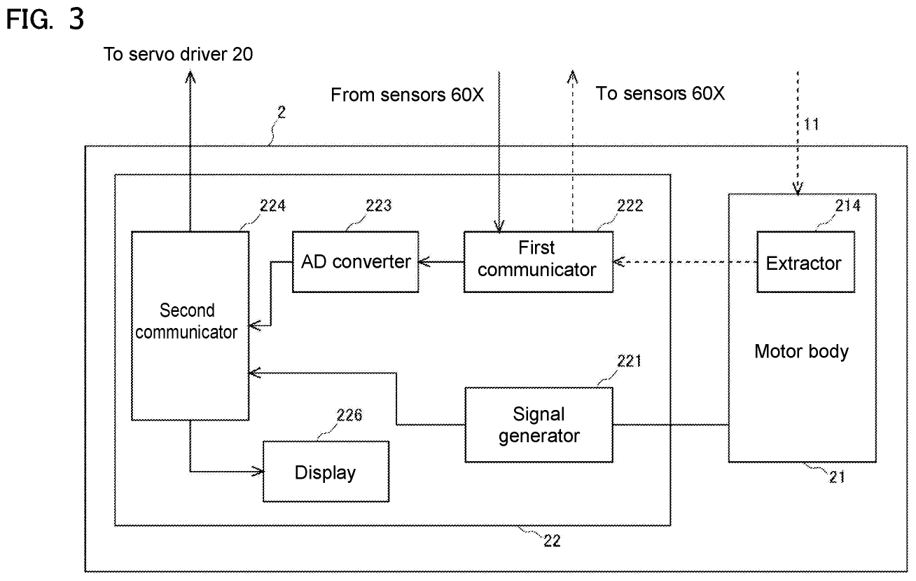

FIG. 3 is a schematic diagram of the motor 2 in the first example, specifically showing the functional components of the encoder 22. The encoder 22 includes a signal generator 221, a first communicator 222, an analog-digital (AD) converter 223, a second communicator 224, and a display 226. For sensors (described later) that output digital signals to communicate with the first communicator 222, the AD converter 223 may be eliminated.

The signal generator 221 detects motion of the motor body 21 of the motor 2 driven by the servo driver 20, and generates a feedback signal indicating the detected motion. The feedback signal is output to the second communicator 224. The feedback signal includes, for example, information about the rotational position (angle) of the rotation shaft of the motor body 21, the rotational speed of the rotation shaft, and the rotational direction of the rotation shaft. The signal generator 221 may generate, for example, any of known incremental or absolute signals.

The first communicator 222 receives detection signals through wireless communication from the above sensors (e.g., the origin sensor 61a, the limit sensors 62 and 63a, and the fully closed sensor 64, referred to as the sensors 60X in FIG. 3). The first communicator 222 may use any wireless communication scheme. In FIG. 2, lines r1 indicate wireless communication to the first communicator 222 in the encoder 22 in the motor 2, and lines r10 indicate wireless communication to the first communicator (functionally the same as the first communicator 222) in the encoder 22a in the motor 2a. In the example shown in FIG. 2, one or more sensors (e.g., the origin sensor 61) for the control shaft drivable by the motor 2 perform wireless communication with the encoder 22a in the motor 2a rather than with the encoder 22 in the motor 2. This occurs when, for example, the sensors are nearer the encoder 22a (the motor 2a) than the encoder 22 (the motor 2) and allow more stable wireless communication with higher-intensity signals with the encoder 22a than with the encoder 22. In other words, in the present embodiment, the encoder (motor) to be connected to each sensor is selected to allow more stable wireless communication. The selection process is described in detail later. The same applies to one or more sensors (e.g., the origin sensor 61a) for the control shaft drivable by the motor 2a.

The first communicator 222 serves as an input interface for receiving the detection signal from each sensor through wireless communication. The input detection signal is output from the first communicator 222 to the AD converter 223. The AD converter 223 performs analog-to-digital conversion on the detection signal from the first communicator 222 and outputs the resultant digital signal to the second communicator 224.

The second communicator 224 is an interface for communicating with the servo driver 20. The second communicator 224 in the present embodiment transmits, through wireless communication, feedback signals and detection signals from the sensors to the communicator 28 in the servo driver 20 for servo control by the control unit 27. The second communicator 224 may use any wireless communication scheme. In FIG. 2, a line r2 indicates wireless communication to the servo driver 20 from the second communicator 224 in the encoder 22 in the motor 2, and a line r20 indicates wireless communication to the second communicator (functionally the same as the second communicator 224) in the encoder 22a in the motor 2a.

In the example shown in FIG. 2, the encoder 22 in the motor 2 is connected, through wireless communication, to sensors (the origin sensor 61a and the limit sensor 63a) that are not used for the control shaft drivable by the motor 2. In this state, detection signals from these sensors are transmitted to the servo driver 20 with the second communicator 224, instead of being transmitted to the servo driver 20a that is an intended destination. In the present embodiment, each sensor is linked to the servo driver that is an intended destination of the detection signal. The linking process is described in detail later. The linking process allows the second communicator 224 to identify the destination servo driver (the servo driver 20 or the servo driver 20a) accurately. The second communicator 224 can transmit detection signals to the servo driver 20a using the communicator 28 in the servo driver 20 through the network 42. The same applies to sensors (the origin sensor 61 and the limit sensor 63) that are connected to the encoder 22a in the motor 2a through wireless communication and are not used for the control shaft drivable by the motor 2a.

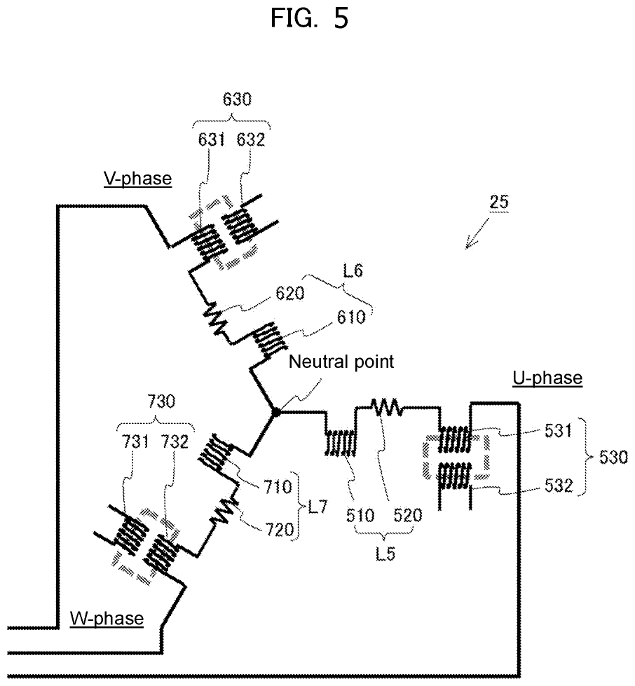

The first communicator 222 will now be described again. The first communicator 222 is also a functional unit for supplying power from the motor 2 partially to the sensors 60X with a contactless power transmission scheme using wireless communication. Each sensor 60X includes an antenna that receives a power transmission signal transmitted (output) from the first communicator 222, a rectifier that generates DC power for driving the sensor from the signal received by the antenna, and a storage battery. The first communicator 222 may supply power to the sensors 60X with any contactless power transmission scheme using wireless communication. In the motor 2, the power supplied from the servo driver 20 through the power line 11 is partially extracted by an extractor 214 included in the motor body 21. The extracted power is transmitted to the first communicator 222 in the encoder 22 and is further transmitted to the sensors 60X with a predetermined contactless power transmission scheme. The extractor 214 may use, for example, a transformer 530 and other transformers shown in FIG. 5 (described later) to extract power.

The power transmission signal transmitted from the first communicator 222 has the intensity controlled based on information included in the detection signal from each sensor 60X indicating the power for driving the sensor 60X. The information indicating the power for driving may include, for example, a charge request signal that is output from each sensor 60X in response to its storage battery having the remaining level less than or equal to a predetermined percentage to the full capacity, or a signal indicating the charge percentage. This avoids power waste caused by excessive power transmission from the first communicator 222.

The system in the example shown in FIG. 3 performs contactless power transmission to the sensors 60X with the first communicator 222 through wireless communication. In some embodiments, the system may perform contactless power transmission with a functional unit (e.g., a power supply unit) other than the first communicator 222 without using wireless communication. Examples of schemes without using wireless communication include electromagnetic induction, magnetic resonant coupling, and capacitive coupling.

The display 226 displays information about the sensor 60X with its detection signal input into the first communicator 222. The detection signal transmitted from the sensor 60X includes identification information about the sensor. The display 226 displays the identification information to notify the user of the sensor 60X connected to the motor 2 through wireless communication.

The motor 2 in the first example receives detection signals from the sensors 60X with the first communicator 222 through wireless communication and transmits the signals to the second communicator 224, which then transmits the signals to the servo driver 20 through wireless communication. The motor 2 also transmits, with the first communicator 222, power transmission signals for powering the sensors 60X. The motor 2 with this structure can also serve as a repeater for information in the servo system. The motor 2 is an actuator for driving the corresponding control shaft and also serves as a repeater for information. This facilitates creation of the network for information in the servo system with reduced workload.

### SECOND EXAMPLE

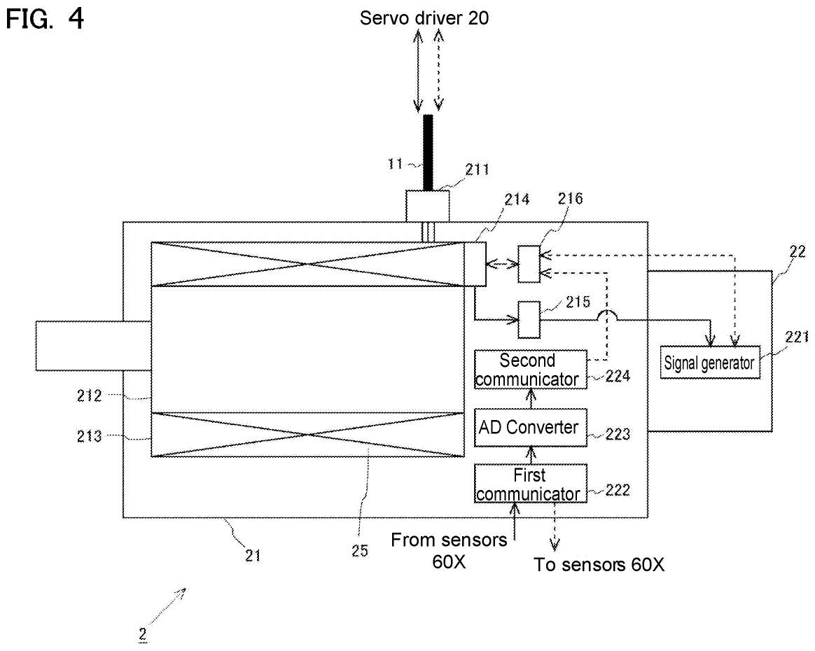

A second example will now be described with reference to FIGS. 4 and 5. FIG. 4 is a schematic diagram of a motor 2 in the second example. FIG. 5 is a diagram of a winding structure in the motor 2. The motor 2 is a three-phase (U-phase, V-phase, and W-phase) AC motor and includes a motor body 21 and an encoder 22. The motor body 21 includes a rotor 212 and a stator 213. The rotor 212 incorporates permanent magnets and is supported in a rotatable manner. The stator 213 includes a winding unit 25 including stator cores formed from magnetic steel and coils wound around the stator cores. In the winding unit 25 in the present embodiment, the winding portions for the respective phases are Y-connected, but the winding portions may be delta-connected instead. The coils may be wound around the stator cores with either distributed winding or concentrated winding in the present embodiment. The structure shown in FIG. 4 is a schematic representation. The technical concept of the present invention is applicable to a motor with any structure.

The power line 11 for supplying driving power from the servo driver 20 is connected to a connector 211. The connector 211 is connected to the winding portions for the respective phases of the winding unit 25. The motor 2 includes an extractor 214 for extracting, as power for the encoder, a part of the driving power supplied to the coils in the winding unit 25 using predetermined transformers (refer to 530, 630, and 730 in FIG. 5, described in detail later) in the winding unit 25. More specifically, the extractor 214 supplies, together with the winding unit 25 in the motor body 21, AC power to the primary coils in the transformers, and extracts a driving current for the encoder 22 at the secondary coils.

The extractor 214 extracts the power output from the secondary coils in the transformers as the power for the encoder 22. The power is rectified by a supply unit 215 and converted as appropriate with a DC-DC converter included in the supply unit 215 into a DC voltage usable for driving the encoder 22. The supply unit 215 is electrically connectable to the encoder 22 attached to the motor body 21 to supply DC power to the encoder 22, or more specifically, to the signal generator 221 that detects rotation of the rotor 212 and generates a feedback signal. The supply unit 215 may include a secondary battery that can store DC power resulting from rectification. The secondary battery can supply power to the encoder 22 with no or very low driving current flowing through the winding unit 25.

The motor 2 in the present embodiment allows transmission and reception of signals between the winding unit 25 in the motor body 21 and the signal generator 221 in the encoder 22 and between the winding unit 25 and the sensors 60X using the extraction process with the extractor 214. Signals are transmitted or received with a signal exchange unit 216 using the above transformers. In some embodiments, signals may be transmitted or received with a signal exchange unit 216 using transformers for communication other than the above transformers. To transmit a signal from the winding unit 25 to the signal generator 221, the extractor 214 can supply AC power with a superimposed predetermined signal to the primary coils in the transformers in the winding unit 25 and generate a current corresponding to the signal at the secondary coils in the transformers. The extracted corresponding current can then be transmitted to the signal generator 221 with the signal exchange unit 216. To accurately transmit information included in the signal, the signal exchange unit 216 transmits the signal without rectifying the corresponding current extracted by the extractor 214. For the extracted corresponding current being weak, the signal exchange unit 216 may perform predetermined amplification.

To transmit a signal from the signal generator 221 to the winding unit 25, AC power including the signal is supplied to the secondary coils in the transformers through the signal exchange unit 216. The extractor 214 can then generate a current corresponding to the signal at the primary coils in the transformers to allow the current to flow through the coils in the winding unit 25. In this case as well, the signal exchange unit 216 may perform predetermined amplification of the predetermined signal. The motor 2 includes the motor body 21 including a first communicator 222, an AD converter 223, and a second communicator 224. These functional units are substantially the same as the functional units shown in FIG. 3 and are not described in detail. Detection signals from the sensors 60X may also be transmitted from the second communicator 224 to the winding unit 25 through the signal exchange unit 216 as described above.

The coils in the winding unit 25 are electrically connected to the servo driver 20 through the power line 11. This allows signals to be transmitted from the encoder 22 to the servo driver 20 or allow detection signals received from the sensors 60X by the motor 2 to be transmitted to the servo driver 20 using AC power corresponding the signals from the signal generator 221 or the second communicator 224. The system in the present example thus eliminates the communicator 28 shown in FIG. 1.

An example structure of the winding unit 25 in the motor body 21 and the transformers included in the winding unit 25 will now be described with reference to FIG. 5. The winding unit 25 includes three-phase winding portions L5, L6, and L7 for the U-, V-, and W-phases. The winding portions for the respective phases are Y-connected and have a connection being a neutral point. In FIG. 5, the U-phase winding portion L5 has an inductance component 510 and a resistance component 520. Similarly, the V-phase winding portion L6 has an inductance component 610 and a resistance component 620. The W-phase winding portion L7 has an inductance component 710 and a resistance component 720.

The structure includes transformers for the respective phases to form the extractor 214. More specifically, for the U-phase, the winding portion L5 is connected in series to a primary coil 531 in a U-phase transformer 530. For the V-phase, the winding portion L6 is connected in series to a primary coil 631 in a V-phase transformer 630. For the W-phase, the winding portion L7 is connected in series to a primary coil 731 in a W-phase transformer 730. A secondary coil 532 in the transformer 530 for the U-phase, a secondary coil 632 in the transformer 630 for the V-phase, and a secondary coil 732 in the transformer 730 for the W-phase are connected to the supply unit 215. The secondary coils 532, 632, and 732 are also connected to the signal exchange unit 216.

The transformers for the respective phases basically have the same ratio of turns (the ratio of the number of turns of the secondary coil to the number of turns of the primary coil), but may have different ratios of turns. In the example shown in FIG. 5, transformers are included for all the three phases, and each transformer has the secondary coil connected to the supply unit 215 and the signal exchange unit 216. In some embodiments, one or more transformers may be included for one or two of the three phases, and the transformer(s) may have the secondary coil connected to the supply unit 215 and the signal exchange unit 216. In some embodiments, transformers may be included for all the three phases, and one or more of the transformers may have the secondary coil connected to the supply unit 215 with the remaining transformer(s) having the secondary coil connected to the signal exchange unit 216. In this case, the transformer(s) connected to the supply unit 215 to supply power to the encoder 22 may have a ratio of turns selected as appropriate. The transformer(s) connected to the signal exchange unit 216 to transmit or receive signals to or from the encoder 22 may have a ratio of turns selected as appropriate.

The winding unit 25 and the transformers 530, 630, and 730 with the above structure allow the extractor 214 to extract, as the driving power for the encoder 22, a part of the power supplied to the motor 2 through the power line 11. The power can also be transmitted to the sensors 60X with the first communicator 222 in the first example shown in FIG. 3. This structure can constantly and stably supply power to the encoder 22 while the motor 2 is being driven. The structure also eliminates cabling for the encoder 22, greatly reducing the work and the cost for cabling.

The motor 2 receives detection signals from the sensors 60X with the first communicator 222 through wireless communication and transmits the signals to the second communicator 224, which then transmits the signals to the servo driver 20 through the signal exchange unit 216. The servo driver 20 may receive detection signals from one or more sensors 60X corresponding to the servo driver 20a. In this case, the servo driver 20 can transmit the detection signals to the servo driver 20a through the network 42. The first communicator 222 in the present example may also transmit power transmission signals for powering the sensors 60X. The motor 2 with this structure can also serve as a repeater for information in the servo system. The motor 2 is an actuator for driving the corresponding control shaft and also serves as a repeater for information. This facilitates creation of the network for information in the servo system with reduced workload.

### THIRD EXAMPLE

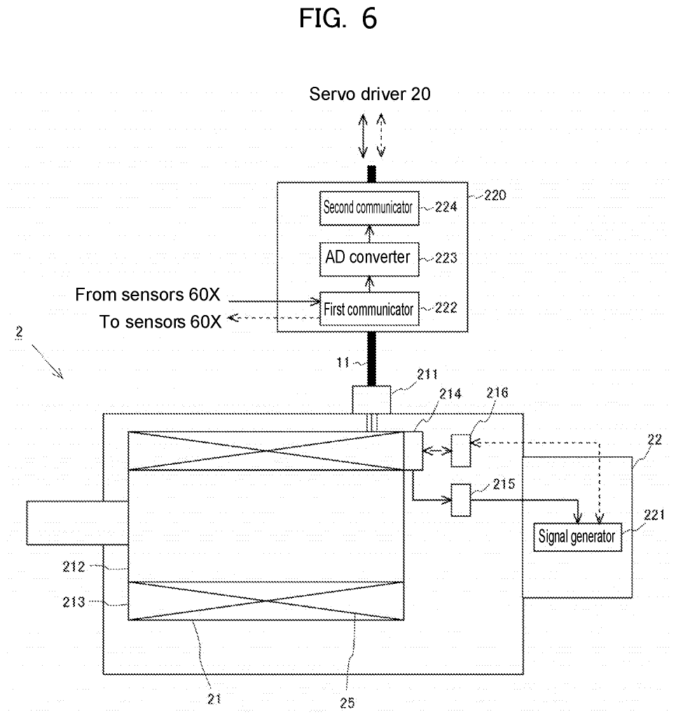

A third example will now be described with reference to FIG. 6. FIG. 6 is a schematic diagram of a motor 2 in the third example. The system in the third example differs from the system in the second example shown in FIG. 4 in a signal processor 220 for receiving detection signals from sensors 60X in the motor 2 and transmitting the detection signals to a servo driver 20. The other components are basically the same as described above. The signal processor 220 will now be described in detail.

The signal processor 220 includes a first communicator 222, an AD converter 223, and a second communicator 224 similar to the functional units shown in the second example. The signal processor 220 is separate from the motor body 21 but is included in the motor 2 together with a power line 11. The signal processor 220 is detachably attached to the power line 11 at any position and superimposes, on the current flowing through the power line 11, a detection signal from a sensor 60X to be output from the second communicator 224. In other words, the signal processor 220 transmits the detection signal to the servo driver 20 through the power line 11 with the function equivalent to the function of the extractor 214 using the transformers in the second example.

The motor 2 with this structure can also serve as a repeater for information in the servo system. The motor 2 is an actuator for driving the corresponding control shaft and also serves as a repeater for information. This facilitates creation of the network for information in the servo system with reduced workload. The signal processor 220 is detachably attached to the power line 11 and can thus be attached easily to allow wireless communication between the first communicator 222 and the sensors 60X.

### Other Examples

Although the motors 2 in the first to third examples have been described with reference to FIGS. 3 to 6, motors in other examples may be used. The motor 2 in each of the above examples relays information between the sensors 60X and the servo driver 20. However, the motor 2 may relay information between a device included in the servo system other than the sensors 60X and a device included in the servo system other than the servo driver 20 or another device not included in the servo system. For example, the motor 2 may relay information between the servo driver 20 and a safety device for the control shaft in the equipment shown in FIG. 2. In this case, the safety device transmits a command for stopping the motor 2 to the servo driver 20 or the PLC 5 through the motor 2 to cause a process for safety to be performed, such as emergency stop of the motor 2. In another example, the motor 2 may receive a detection signal from a sensor 60Y and transmit the detection signal to the servo driver 20a through wireless communication, or in other words, directly transmit the detection signal to the servo driver 20a without using the servo driver 20 or the network 42. The motor 2 may directly relay communication between each sensor and the PLC 5, and may communicate with the motor 2a as appropriate to relay communication between, for example, each sensor and the motor 2a. The motor 1 in the servo system may relay various items of information.

In the example shown in FIG. 3, the second communicator 224 transmits detection signals from the sensors 60X to the servo driver 20 through wireless communication. In another example, the second communicator 224 may transmit the detection signals to the servo driver 20 through a communication cable connecting the encoder 22 in the motor 2 to the servo driver 20.

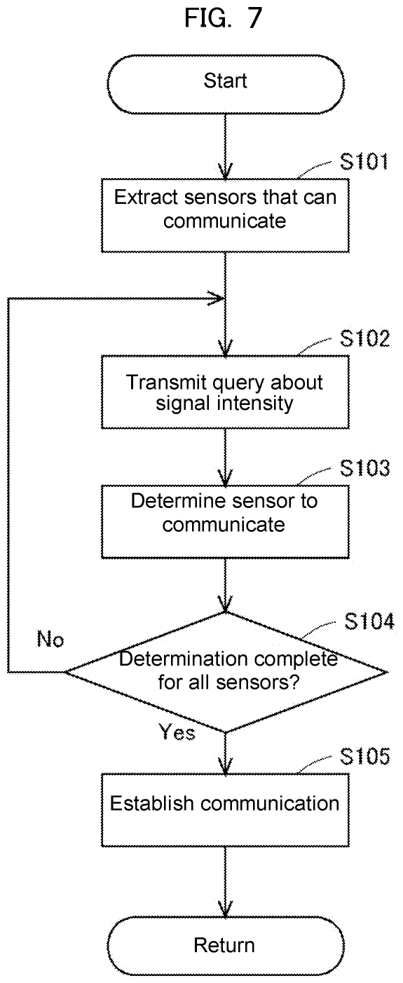

A process of determining the sensor that allows stable wireless communication with the first communicator 222 in the motor 2 will now be described with reference to FIG. 7. As described above with reference to FIG. 2, one or more sensors (e.g., the origin sensor 61) for the control shaft drivable by the motor 2 perform wireless communication with the motor 2a, without performing wireless communication with the motor 2. This is due to a lower-intensity signal for wireless communication between the sensor(s) and the motor 2. In wireless communication, a higher-intensity detection signal can be received more stably from each sensor 60X, and a higher-intensity power transmission signal can be transmitted more stably to each sensor 60X. FIG. 7 shows a flowchart of the process in the servo system in the present embodiment to determine the target sensor for wireless communication with the first communicator 222 in each of the motors 2 and 2a, or in other words, to determine the combination of each of the motors 2 and 2a with the corresponding sensor.

The process in FIG. 7 is performed in each of the servo drivers 20 and 20a in cooperation with the other of the servo drivers 20 and 20a. The process in the servo driver 20 will be described in detail below. In S101, sensors that can communicate with the motor 2 drivable by the servo driver 20 are extracted. The determination as to whether each sensor can communicate with the motor 2 is performed based on whether the signal intensity is greater than or equal to a predetermined threshold for wireless communication with the first communicator 222 in the motor 2. In the present embodiment, all the sensors can communicate with the motor 2, including the origin sensors 61 and 61a, the limit sensors 62, 63, 62a, and 63a, and the fully closed sensors 64 and 64a. For the motor 2a as well, all the sensors can communicate with the motor 2a. After the processing is complete in step S101, the processing advances to step S102.

In S102, a query is transmitted to another servo driver (the servo driver 20a in the present embodiment) about the signal intensity for wireless communication between the motor drivable by the other servo driver (the motor 2a in the present embodiment) and each sensor. In S103, the signal intensity with the motor 2 is compared with the signal intensity with the motor 2a obtained in response to the query to determine the sensor to communicate with the motor 2. For a sensor that can communicate with both the motor 2 and the motor 2a, the motor with the higher signal intensity is determined to communicate with the sensor. In the example shown in FIG. 2, the sensors to communicate with the first communicator 222 in the motor 2 are determined to be the origin sensor 61a, the limit sensors 62 and 63a, and the fully closed sensor 64. The sensors to communicate with the first communicator in the motor 2a are determined to be the origin sensor 61, the limit sensors 62a and 63, and the fully closed sensor 64a.

In S104, the servo drivers 20 and 20a communicate with each other to determine whether the target motor for wireless communication has been determined for all the sensors included in the servo system. The processing advances to S105 in response to an affirmative determination result, and repeats the processing in S102 to S104 in response to a negative determination result. In S105, wireless communication is established between each sensor and the motor 2 in accordance with the result of determination in S103.

Wireless communication is established between each sensor and the motor in accordance with the signal intensity for wireless communication. This allows more stable wireless communication between each sensor and the motor, or in other words, more stable wireless communication with the first communicator 222. The first communicator 222 also transmits a power transmission signal to each sensor. The structure thus also allows more stable power transmission to each sensor with the above contactless power transmission scheme.

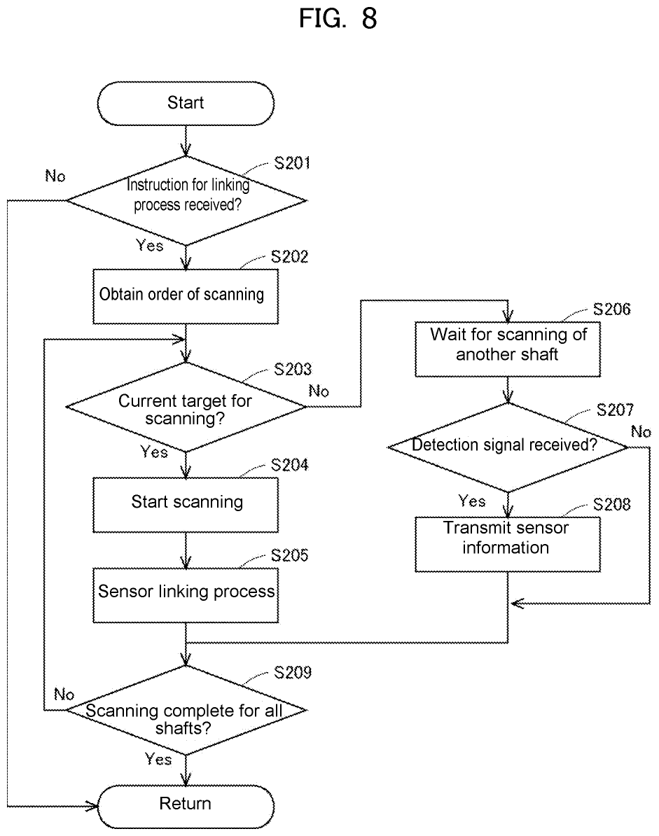

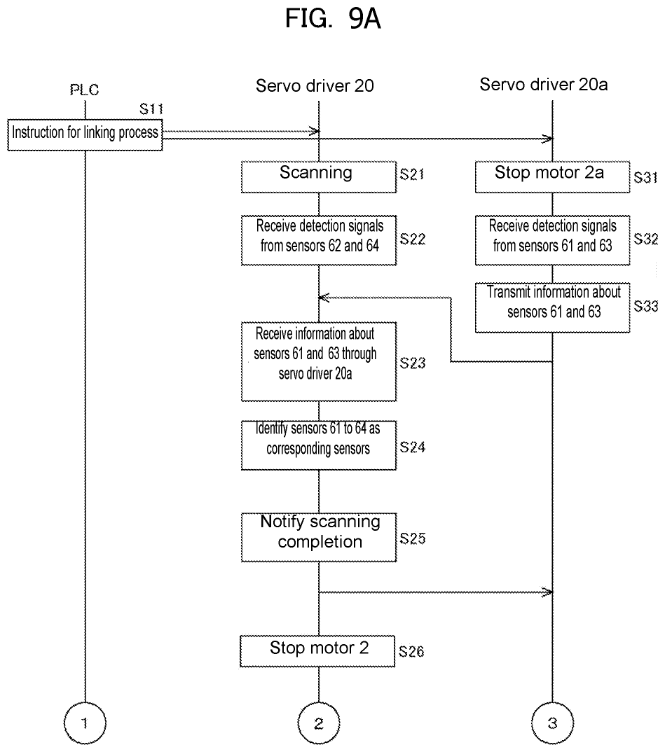

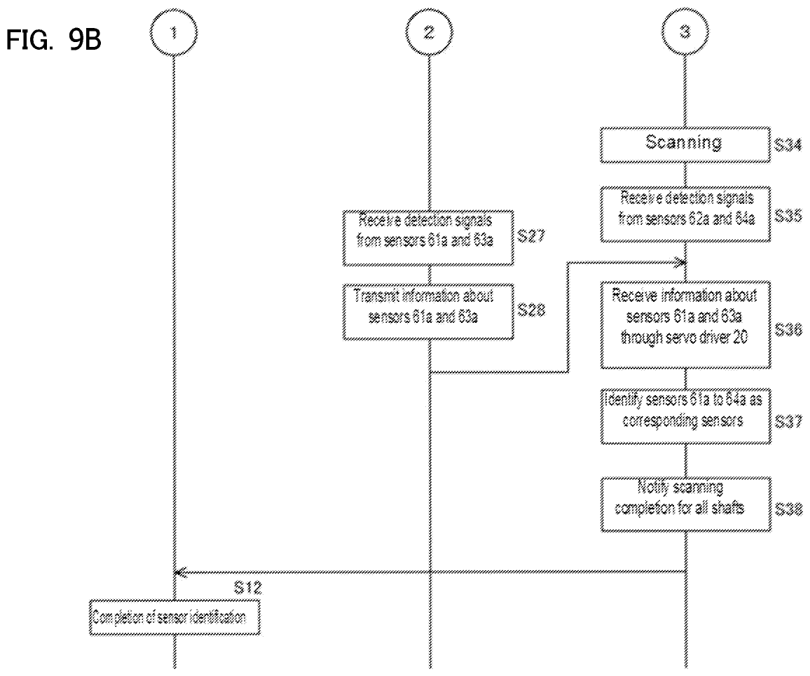

A linking process for linking each sensor to the servo driver that is an intended destination of the detection signal from the sensor will now be described with reference to FIGS. 8, 9A, and 9B. As described above with reference to FIG. 2, the processing shown in FIG. 7 is performed to cause the encoder 22 in the motor 2 to be connected, through wireless communication, to the origin sensor 61a and the limit sensor 63a that are not used for the control shaft drivable by the motor 2. The linking process is thus performed to cause the detection signals from these sensors to be transmitted to the servo driver 20a as an intended destination using the second communicator 224. The result of the linking process is also stored into the second communicator 224 to select the destination of the detection signals appropriately. FIG. 8 is a flowchart of the linking process. FIGS. 9A and 9B are sequence diagrams showing communication between the PLC 5 and the servo drivers 20 and 20a in the linking process.

A sequence of the process performed in each servo driver will now be described with reference to FIG. 8. The process in the servo driver 20 will be described below. The process shown in FIG. 8 is repeatedly performed at predetermined time intervals. In S201, the determination is performed as to whether an instruction for performing the linking process has been received from the PLC 5. In response to an affirmative determination result obtained in S201, the processing advances to S202. In response to a negative determination result obtained in S201, the process is complete. In S202, the order of scanning by the servo drivers is obtained in accordance with the instruction for the linking process received from the PLC 5. The scanning refers to a first predetermined operation of displacing the precision table 53 by driving the output shaft 32 of the motor 2 alone (without driving the output shaft 32a of the motor 2a), and refers to a second predetermined operation of displacing the precision table 53a by driving the output shaft of the motor 2a alone (without driving the output shaft 32 of the motor 2). In other words, the scanning refers to the operation of the motor moving the precision table from one end to the other end (across the movable range) of the control shaft for the linking process, and extracting sensors that output detection signals in response to the corresponding motor alone being driven. More specifically, the motor 2 is driven at low and constant speed in the state of the precision table 53 in contact with a stopper (not shown) at one end of the movable range along the screw shaft 52 up to the state of the precision table 53 in contact with a stopper (not shown) at the other end. The motor 2 has its torque controlled during the drive to minimize the impact caused by the precision table 53 coming in contact with the stoppers. In the present embodiment, the servo driver 20 performs the first scanning for the control shaft, and the servo driver 20a performs the second scanning for the control shaft.

In S203, the determination is performed as to whether the servo driver 20 is a current target for the scanning. In response to an affirmative determination result obtained in S203, the processing advances to S204. In response to a negative determination result obtained in S203, the processing advances to S206. In S204, the scanning is started for the control shaft with the servo driver 20, or in other words, the scanning with the motor 2 is started. For the screw shaft 52 with the limit sensor 62 located at one end and the limit sensor 63 located at the other end, the scanning causes the limit sensor 62, the origin sensor 61, and the limit sensor 63 to transmit, in this order, their detection signals through the motors 2 and 2a to the servo drivers 20 and 20a. The detection signal from the fully closed sensor 64 is transmitted to the servo driver 20 throughout the scanning. After the processing is complete in step S204, the processing advances to step S205.

In S205, the linking process is performed for each sensor through the scanning started in S104. More specifically, the scanning causes the limit sensor 62 and the fully closed sensor 64 to transmit their detection signals to the first communicator 222 in the motor 2 and further to the second communicator 224, which then transmits the detection signals to the servo driver 20. These sensors are thus identified as sensors corresponding to the servo driver 20. The scanning further causes the origin sensor 61 and the limit sensor 62 to transmit their detection signals to the first communicator in the motor 2a and further to the second communicator 224, which then transmits the detection signals to the servo driver 20a. The servo driver 20a transmits information about these sensors to the servo driver 20 currently performing the scanning, and the servo driver 20 receives the information. The information about the sensors includes identification information identifying each sensor. The sensors are thus also identified as sensors corresponding to the servo driver 20 based on the received information.

In response to a negative determination result obtained in S203, the servo driver 20 waits for the scanning of another control shaft in S206. In the present embodiment, the servo driver 20 performs the processing in S206 and is in the wait state while the servo driver 20a is performing the scanning of the control shaft. The servo driver 20 in the wait state can receive the detection signals from the origin sensor 61a and the limit sensor 63 assigned to the servo driver 20a. In S207, the determination is performed as to whether a detection signal has been received from any of these sensors. The sensor is to be linked to a servo driver other than the servo driver 20. Thus, in response to an affirmative determination result obtained in S207, the processing advances to S208 to transmit sensor information about the sensor. The destination of the sensor information is the servo driver corresponding to the control shaft being scanned at the reception of the detection signal. The processing advances to S209 upon completion of the processing in S208 or in response to a negative determination result obtained in S207.

In S209, the determination is performed as to whether the scanning is complete for all the control shafts in the servo system. The process is complete in response to an affirmative determination result obtained in S209, and repeats the processing in S203 to S208 in response to a negative determination result obtained in S209. In the present embodiment, an affirmative determination result obtained in S209 indicates that the origin sensor 61, the limit sensors 62 and 63, and the fully closed sensor 64 are identified as sensors corresponding to the servo driver 20. Information about the link between the servo driver 20 and these sensors is thus stored into a memory in the servo driver 20. The affirmative determination result obtained in S209 also indicates that the origin sensor 61a, the limit sensors 62a and 63a, and the fully closed sensor 64a are identified as sensors corresponding to the servo driver 20a. Information about the link between the servo driver 20a and these sensors is thus stored into a memory in the servo driver 20a. The information about the link between the sensors and the servo drivers is also stored into memories in the motor 2 and the motor 2a. The information is used to identify the destinations of detection signals from the second communicator in each motor.

The communication between the PLC 5 and the servo drivers 20 and 20a will now be described with reference to FIGS. 9A and 9B for the process shown in FIG. 8 performed in each of the servo drivers 20 and 20a. FIGS. 9A and 9B show a sequence of processing. In S11, the PLC 5 transmits an instruction for the linking process to all the servo drivers 20 and 20a included in the servo system. Each servo driver is to perform the process shown in FIG. 8 in accordance with the instruction. In S21, the servo driver 20 drives the motor 2 and starts the scanning through the processing in S202 and S203 in FIG. 8 (refer to the processing in S204 in FIG. 8). In this state, the motor 2a is stopped (refer to the processing in S31). Through the scanning, the servo driver 20 receives the detection signals from the limit sensor 62 and the fully closed sensor 64 with the relaying motor 2 in S22.

Through the above scanning, the servo driver 20a receives the detection signals from the origin sensor 61 and the limit sensor 63 with the relaying motor 2a (refer to the processing in S32). In this state, the servo driver 20a waits for the scanning of the control shaft with the servo driver 20 with the processing in S206 shown in FIG. 8. Upon receiving the detection signals from the origin sensor 61 and the limit sensor 63, the servo driver 20a transmits information about the origin sensor 61 and the limit sensor 63 to the servo driver 20 (refer to the processing in S33). The servo driver 20 receives the information about these sensors in S23.

In S24, the servo driver 20 identifies the origin sensor 61, the limit sensors 62 and 63, and the fully closed sensor 64 as sensors corresponding to the servo driver 20. In other words, the servo driver 20 performs the linking process (refer to the processing in S205 in FIG. 8). The result of the linking process is stored into the memory in each of the servo driver 20 and the motors 2 and 2a. In S25, the servo driver 20 notifies that the scanning of its control shaft is complete to the servo driver 20a having the control shaft to be scanned next. The servo driver 20a then determines that the servo driver 20a is a current target to perform the scanning of its control shaft. After the notification, the servo driver 20 stops its motor (refer to the processing in S26) and waits for the scanning of the control shaft with the servo driver 20a in the processing in S206 shown in FIG. 8.

In S34, the servo driver 20a drives the motor 2a and starts the scanning (refer to the processing in S204 in FIG. 8). Through the scanning, the servo driver 20a receives the detection signals from the limit sensor 62a and the fully closed sensor 64a with the relaying motor 2a in S35.

Through the above scanning, the servo driver 20 receives the detection signals from the origin sensor 61a and the limit sensor 63a with the relaying motor 2 (refer to the processing in S27). Upon receiving the detection signals from the origin sensor 61a and the limit sensor 63a, the servo driver 20 transmits information about the origin sensor 61a and the limit sensor 63a to the servo driver 20a (refer to the processing in S28). The servo driver 20a receives the information about these sensors in S36.

In S37, the servo driver 20a identifies the origin sensor 61a, the limit sensors 62a and 63a, and the fully closed sensor 64a as sensors corresponding to the servo driver 20a. In other words, the servo driver 20a performs the linking process (refer to the processing in S205 in FIG. 8). The result of the linking process is stored into the memory in each of the servo driver 20a and the motors 2 and 2a. In S38, the servo driver 20a notifies, to the PLC 5, that the scanning is complete for all the control shafts upon completion of the scanning of the control shaft with the servo driver 20a. The PLC 5 then determines that the linking process is complete in S12.

The motor to be first connected to each sensor through wireless communication is determined for stable wireless communication. The servo drivers 20 and 20a identify their corresponding sensors through the above linking process. This allows the detection signal from each sensor to be efficiently transmitted to the assigned servo driver with the motors serving as repeaters. This facilitates creation of the network in the servo system.

### Second Embodiment

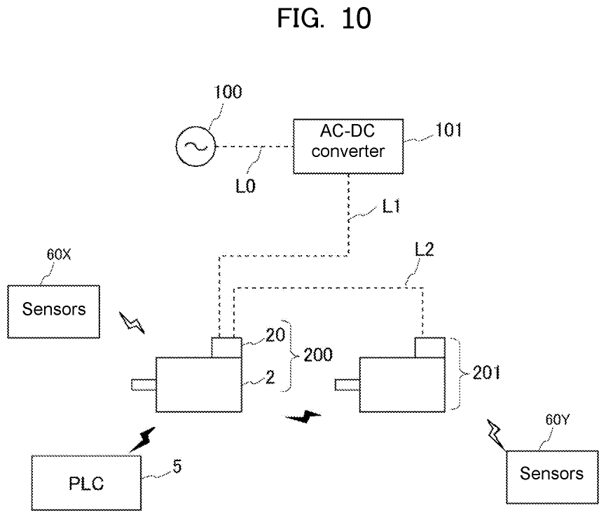

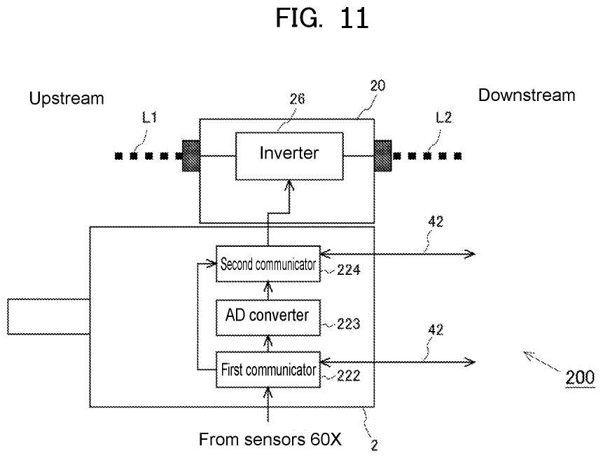

A second embodiment of the present disclosure will now be described with reference to FIGS. 10 and 11. FIG. 10 is a schematic diagram of a servo system according to the present embodiment. The servo system includes a PLC 5, integral motors 200 and 201, and sensors 60X and 60Y. The integral motors 200 and 201 each include the motor 2 and the servo driver 20 described in the first embodiment integral with each other. This structure eliminates a power line 11 connecting the motor and the servo driver.

In the present embodiment, AC power is supplied from an external AC power supply 100 through a power system LO and is converted into DC power by an AC-DC converter 101. The DC power is supplied to an inverter 26 included in the integral motor 200. More specifically, the integral motor 200 has a power input end connected to an output end of the AC-DC converter 101 through a power supply cable L1. The integral motor 201 has a power input end connected to a power output end of the integral motor 200 through a power supply cable L2. In other words, the integral motors are connected to the power supply cables L1 and L2 in a daisy chain to receive DC power generated by the AC-DC converter 101.

The integral motor 200 will now be described with reference to FIG. 11. The integral motor 201 has substantially the same structure as the integral motor 200. The integral motor 200 includes the motor 2 including a first communicator 222, an AD converter 223, and a second communicator 224 as in the above embodiments. These functional units have substantially the same structures as in the above embodiments. More specifically, the first communicator 222 can perform wireless communication with the sensors 60X and the PLC 5. The first communicator 222 receives command signals from the PLC 5 for controlling the integral motors 200 and 201. The output from the first communicator 222 is transmitted to the second communicator 224 through or without being through the AD converter 223 in accordance with the types of the signals.

The second communicator 224 determines the destination of the signal (a detection signal from a sensor 60X or a command signal from the PLC 5) received from the first communicator 222 in accordance with the type of the signal. For example, the second communicator 224 may receive, from the first communicator 222, a detection signal from a sensor (e.g., a limit sensor 62) linked to the servo driver 20 or a command signal for the integral motor 200. In this case, the second communicator 224 transmits the received signal using a wire in the motor to a predetermined section (specifically, the servo driver 20) for controlling the motor 2 in the integral motor 200. The second communicator 224 may receive, from the first communicator 222, a detection signal from a sensor (e.g., a limit sensor 63a) linked to the servo driver 20a or a command signal for the integral motor 201. In this case, the second communicator 224 transmits the received signal through wireless communication to the servo driver 20a with the servo driver 20 being bypassed. The communication path including the first communicator 222 and the second communicator 224 thus defines a network 42.

Similarly, the motor included in the integral motor 201 includes a first communicator, an AD converter, and a second communicator. The first communicator in the integral motor 201 performs wireless communication with the sensors 60Y without performing wireless communication with the PLC 5. The first communicator in the integral motor 201 may receive detection signals from the sensors 60Y to be transmitted to the servo driver 20 in the integral motor 200. In this case, the second communicator in the integral motor 201 transmits the detection signals to the first communicator 222 in the integral motor 200 through wireless communication. The second communicator in the integral motor 201 also transmits detection signals from the sensors 60X transmitted from the integral motor 200 and command signals for controlling the integral motor 201, as well as detection signals from the sensors 60Y, to a predetermined section (specifically, the servo driver) for controlling the motor in the integral motor 201 using a wire in the motor.

The integral motors 200 and 201 with this structure can also serve as repeaters for information in the servo system. The motor 2 is an actuator for driving the corresponding control shaft and also serves as a repeater for information. This facilitates creation of the network for information in the servo system with reduced workload.

### Appendix 1

A motor (2) drivable with driving power supplied from a first driver (20) in a servo system, the motor (2) comprising:

a first communicator (222) configured to at least transmit or receive a predetermined signal through wireless communication between a first device (60X) and the motor (2) included in the servo system; and

a second communicator (224) configured to perform predetermined communication of the predetermined signal between a second device (20) and the motor (2).

1. A motor drivable with driving power supplied from a first driver in a servo system, the motor comprising:
a first communicator configured to at least transmit or receive a predetermined signal through wireless communication between a first device and the motor included in the servo system; and
a second communicator configured to perform predetermined communication of the predetermined signal between a second device and the motor.

2. The motor according to claim 1, wherein
the second communicator performs the predetermined communication between the second device and the motor at least partially using a power line connecting the motor and the first driver.

3. The motor according to claim 2, wherein
the motor allows transmission or reception of a signal between an encoder to detect motion of an output shaft of the motor drivable by the first driver and a winding of the motor, and
the first communicator and the second communicator are included in the encoder.

4. The motor according to claim 1, further comprising:
an encoder configured to detect motion of an output shaft of the motor drivable by the first driver,
wherein the first communicator and the second communicator are included in the encoder, and
the second communicator performs the predetermined communication using a communication cable connecting the first driver and the encoder.

5. The motor according to claim 1, further comprising:
a power line connecting the motor and the first driver; and
a signal processor configured to superimpose the predetermined signal on a driving current flowing through the power line or configured to extract the predetermined signal from the driving current flowing through the power line,
wherein the first communicator and the second communicator are included in the signal processor.

6. The motor according to claim 1, wherein
the second communicator performs the predetermined communication through wireless communication between the second device and the motor.

7. The motor according to claim 1, wherein
the first device includes a first sensor configured to detect a predetermined parameter in the servo system,
the first communicator receives a detection signal from the first sensor, and
the second communicator transmits the detection signal received by the first communicator to the first driver being the second device.

8. The motor according to claim 7, wherein
the first sensor detects the predetermined parameter about a displacement of a first driving target drivable by an output shaft of the motor,
the first communicator is located to receive the detection signal from the first sensor, and
before a sensor identification process is complete, a first predetermined operation is performed to displace the first driving target by driving the output shaft of the motor, and in response to the first communicator receiving the detection signal from the first sensor in the first predetermined operation, the second communicator transmits the detection signal received by the first communicator from the first sensor to the first driver to link the first driver and the first sensor.

9. The motor according to claim 8, wherein
the servo system includes a second driver connected to the first driver to allow communication, a second motor drivable with driving power supplied from the second driver, and a second sensor configured to detect a parameter about a displacement of a second driving target drivable by an output shaft of the second motor,
the first communicator is located to receive a detection signal from the second sensor, and
before the sensor identification process is complete, a second predetermined operation is performed to displace the second driving target by driving the output shaft of the second motor, and in response to the first communicator receiving the detection signal from the second sensor in the second predetermined operation, the second communicator transmits the detection signal received by the first communicator from the second sensor to the second driver through the first driver to link the second driver and the second sensor.

10. The motor according to claim 7, wherein
the first sensor detects the predetermined parameter about a displacement of a first driving target drivable by an output shaft of the motor,
the servo system includes a second driver connected to the first driver to allow communication and a second motor drivable with driving power supplied from the second driver,
the second motor receives the predetermined signal from the first sensor through wireless communication, and performs the predetermined communication with the first driver, and
the motor or the second motor is selected to receive the detection signal from the first sensor based on a result of comparison between an intensity of a signal between the first communicator and the first sensor and an intensity of a signal between the first sensor and the second motor.

11. The motor according to claim 10, wherein
in response to the motor receiving the detection signal from the first sensor, the first communicator receives the detection signal from the first sensor, and the second communicator transmits the detection signal received by the first communicator to the first driver, and
in response to the second motor receiving the detection signal from the first sensor, the first communicator receives the detection signal from the second motor, and the second communicator transmits the detection signal received by the first communicator to the first driver.

12. The motor according to claim 7, wherein
the first communicator transmits, to the first sensor with a contactless power transmission scheme, the predetermined signal indicating power for driving the first sensor.

13. The motor according to claim 12, wherein
the first communicator transmits, with the contactless power transmission scheme, the predetermined signal based on information transmitted from the first sensor indicating an amount of power for driving the first sensor.

14. The motor according to claim 12, wherein
the servo system includes a second driver connected to the first driver to allow communication and a second motor drivable with driving power supplied from the second driver,
the second motor receives the predetermined signal from the first sensor through wireless communication, and performs the predetermined communication with the first driver, and
the motor or the second motor is selected to transmit the predetermined signal based on a result of comparison between an intensity of a signal between the first communicator and the first sensor and an intensity of a signal between the first sensor and the second motor.

15. The motor according to claim 1, wherein
the motor includes an integral motor including a motor body and the first driver integral with each other, and the integral motor drives a first driving target, and
the second communicator performs the predetermined communication with the second device through a predetermined section in the integral motor corresponding to the first driver or with the predetermined section being bypassed.

16. The motor according to claim 15, wherein
the first device includes a controller configured to generate a command signal for controlling a plurality of control targets including the first driving target in the servo system,
the second device includes a second driver connected to the predetermined section to allow communication and configured to supply a driving current to a second motor to drive a second driving target,
the first communicator receives a command signal for controlling the second motor from the controller, and
the second communicator transmits the command signal received by the first communicator to the second driver.

17. The motor according to claim 1, wherein
the motor includes an integral motor including a motor body and the first driver integral with each other, and the integral motor drives a first driving target,
the first device includes a controller configured to generate a command signal for controlling the first driving target in the servo system,
the second device includes a predetermined section in the integral motor corresponding to the first driver,
the first communicator receives the command signal from the controller, and
the second communicator transmits the command signal received by the first communicator to the predetermined section.
